(19) United States
(12) Patent Application Publication
(10) Pub. No.: US 2011/0283118 A1
(43) Pub. Date: Nov. 17, 2011

(54) Adaptive power sourcing equipment and related method for power over ethernet applications

(75) Inventor: Sanjaya Maniktala, Fremont, CA (US)

(73) Assignee: BROADCOM CORPORATION, Irvine, CA (US)

(21) Appl. No.: 12/932,881

(22) Filed: Mar. 8, 2011

Related U.S. Application Data
(60) Provisional application No. 61/395,646, filed on May 13, 2010.

(51) Int. Cl. G06F 1/26

(52) U.S. Cl. 713/300

(57) ABSTRACT

There is presented a circuit and a related method for adaptively supplying Power over Ethernet (PoE) by a power sourcing equipment. The circuit comprises first and second power channels coupled to first and second network interfaces of the power sourcing equipment. A shunt device is operated to identify a maximum power characteristic of a powered device. The first power channel provides a first current to the powered device through the first network interface if the maximum power characteristic does not exceed a power threshold. The circuit provides another current to the powered device through the first network interface if the maximum power characteristic is greater than the power threshold. Various embodiments of the present invention may provide a second current to another powered device through the second network interface if the maximum power characteristic of the first and second powered devices does not exceed the power threshold.

### RELATED APPLICATIONS

This application is based on and claims priority from U.S. Provisional Patent Application Ser. No. 61/395,646, filed on May 13, 2010, which is hereby incorporated by reference in its entirety.

### BACKGROUND OF THE INVENTION

1. Field of the Invention

The present invention relates generally to electronic circuits and systems. More particularly, the present invention relates to power circuits and systems.

2. Background Art

Power over Ethernet (PoE) provides an efficient way to deliver power over computer networks. Typically, a PoE system uses a network cable such as a Category 5 (CATS) Ethernet cable to deliver power to a powered device. The network cable usually comprises four pairs of twisted wires. A typical PoE system also includes power sourcing equipment that controls the flow of power to the powered device. One or more network interfaces, such as RJ45 registered jacks, typically connect power sourcing equipment to a network cable.

The Institute of Electrical and Electronics Engineers (IEEE) 802.3af specification discloses a conventional PoE architecture that provides power over two of the four twisted wire pairs of a network cable. Although the conventional IEEE PoE architecture can supply power up to 30 Watts (30 W) in many applications, this architecture usually cannot meet the demands of higher power devices that may require power over all four of a network cable's twisted wire pairs. Thus, the conventional IEEE PoE architecture is often unable to meet the power demands of higher power devices requiring up to, for example, 60 W of power.

To accommodate higher power devices, another conventional PoE architecture provides two field-effect transistors (FETs) or “power channels” that logically tie together two lower power ports to create a single higher power port. Although characterized by accurate output currents, such a virtual parallel architecture is often inflexible. In terms of hardware, the virtual parallel architecture often dedicates two power channels to a single network interface even when a lower power device is attached. Unfortunately, this architecture may require additional silicon and may require a designer to commit to supporting a higher power device at the design stage.

It would be desirable to provide a PoE system that can adaptively assign power channels based on the operating requirements of a powered device. Moreover, safety, compatibility, and other reasons may require the PoE system to be able to disable unused ports and be compatible with existing lower power devices.

Accordingly, there is a need to overcome the drawbacks and deficiencies in the conventional art by providing a solution enabling adaptive power sourcing for PoE applications.

### SUMMARY OF THE INVENTION

There are provided an adaptive power sourcing equipment for Power over Ethernet (PoE) applications, and a related method, substantially as shown in and/or described in connection with at least one of the figures, as set forth more completely in the claims.

### BRIEF DESCRIPTION OF THE DRAWINGS

The features and advantages of the present invention will become more readily apparent to those ordinarily skilled in the art after reviewing the following detailed description and accompanying drawings, wherein: FIG. 1 is a diagram showing conventional power sourcing equipment;

FIG. 2 is a diagram showing a conventional powered device;

FIG. 3 is a diagram of power sourcing equipment for adaptively providing Power over Ethernet (PoE), according to an embodiment of the present invention;

FIG. 4 is a diagram showing several powered devices suitable for use with power sourcing equipment for adaptively providing PoE, according to embodiments of the present invention;

FIG. 5 is a flowchart describing an exemplary method for adaptively providing PoE according to an embodiment of the present invention; and

FIG. 6 is a diagram showing power sourcing equipment for adaptively providing PoE, according to a second embodiment of the present invention.

### DETAILED DESCRIPTION OF THE INVENTION

The present invention is directed to adaptive power sourcing equipment for Power over Ethernet (PoE) applications, and a related method. The following description contains specific information pertaining to the implementation of the present invention. One skilled in the art will recognize that the present invention may be implemented in a manner different from that specifically discussed in the present application. Moreover, some of the specific details of the invention are not discussed in order not to obscure the invention. The specific details not described in the present application are within the knowledge of a person of ordinary skill in the art. The drawings in the present application and their accompanying detailed description are directed to merely exemplary embodiments of the invention. To maintain brevity, other embodiments of the invention, which use the principles of the present invention, are not specifically described in the present application and are not specifically illustrated by the present drawings. It should be borne in mind that, unless noted otherwise, like or corresponding elements among the figures may be indicated by like or corresponding reference numerals.

PoE provides an efficient way to deliver power over computer networks using a network cable, such as a Category 5 (CATS) Ethernet cable, for example. A PoE system usually includes a powered device and power sourcing equipment. One or more network interfaces, such as a pair of RJ45 registered jacks, for example, are typically used to connect power sourcing equipment to the network cable. Unfortunately, the conventional

PoE architecture specified in the Institute of Electrical and Electronics Engineers (IEEE) 802.3af specification does not support supplying more than 30 W of power over more than two of the four twisted wire pairs of a network cable implementing twisted pair wiring.

Another conventional PoE architecture provides up to 60 W of power by virtually paralleling two lower power, e.g., 30 W, ports. Conventional power sourcing equipment 100 in FIG. 1 illustrates such a virtual parallel architecture. As shown, conventional power sourcing equipment 100 may comprise network interface 140 coupled to first power channel 110 and second power channel 120. Voltage source 102, coupled to ground terminal 104, may supply a reference voltage. Data input line 132 and data return line 134 may couple first power channel 110 to network interface 140. Spare input line 136 and spare return line 138 may couple second power channel 120 to network interface 140.

First power channel 110 may comprise power transistor 112, while second power channel 120 may comprise power transistor 122. Network interface 140 typically comprises two pairs of transformers, such as data pair 142 and spare pair 144.

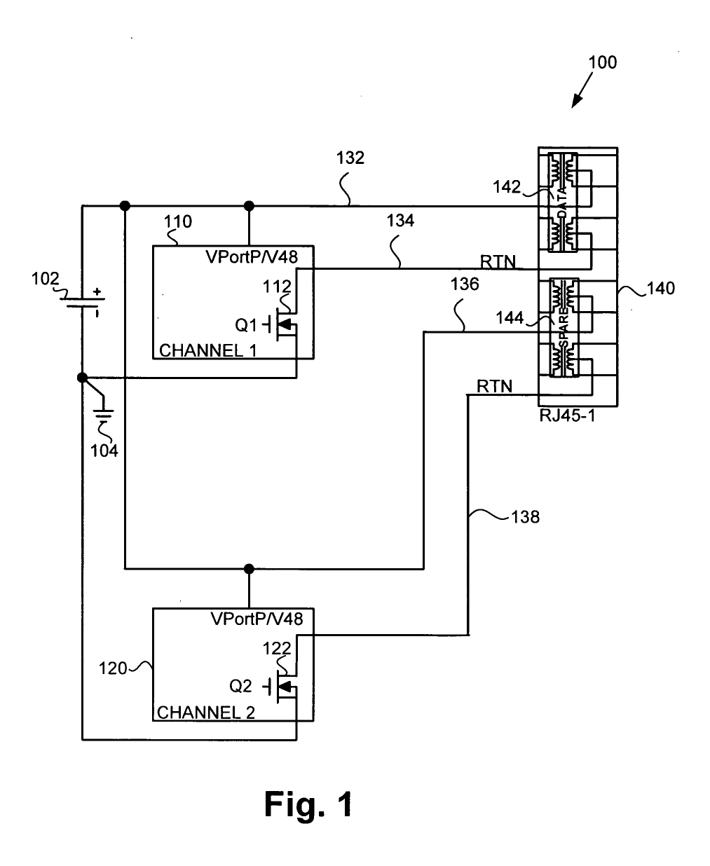

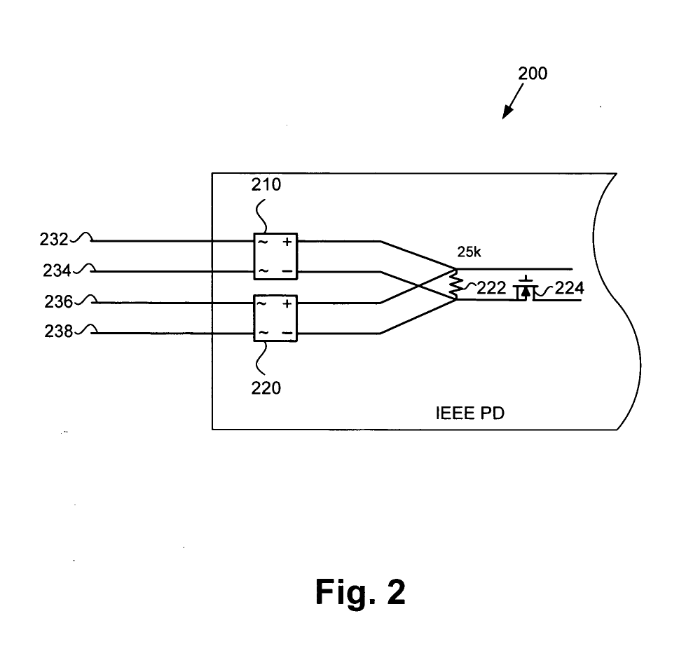

FIG. 2 shows conventional powered device 200, which is compatible with both the conventional IEEE PoE architecture of the IEEE 802.3af specification and the conventional virtual parallel PoE architecture of FIG. 1. Conventional powered device 200 may include data bridge rectifier 210 and spare bridge rectifier 220. Data input line 232 and data return line 234 may couple data bridge rectifier 210 to a network cable such as a CATS Ethernet cable (not shown in FIG. 2). Spare input line 236 and spare return line 238 may couple spare bridge rectifier 220 to the network cable. Conventional powered device 200 may also include resistor 222, such as a 25 kΩ resistor, for example, and switch 224 on the rectified side of bridge rectifiers 210 and 220.

Unfortunately, the conventional PoE architecture of FIGS. 1 and 2 is often inflexible because this architecture requires a designer to commit hardware and firmware to two power channels and two power transistors, such as field-effect transistors (FETs), for example, even though a single power channel and one FET may have sufficed for lower power cases. It would be desirable to avoid over-designing equipment merely to support higher power devices. It would also be desirable to provide a PoE system that can adaptively assign power channels based on the operating requirements of a powered device. For safety, compatibility, and other reasons, the PoE system should be able to disable unused ports and comport with existing lower power devices.

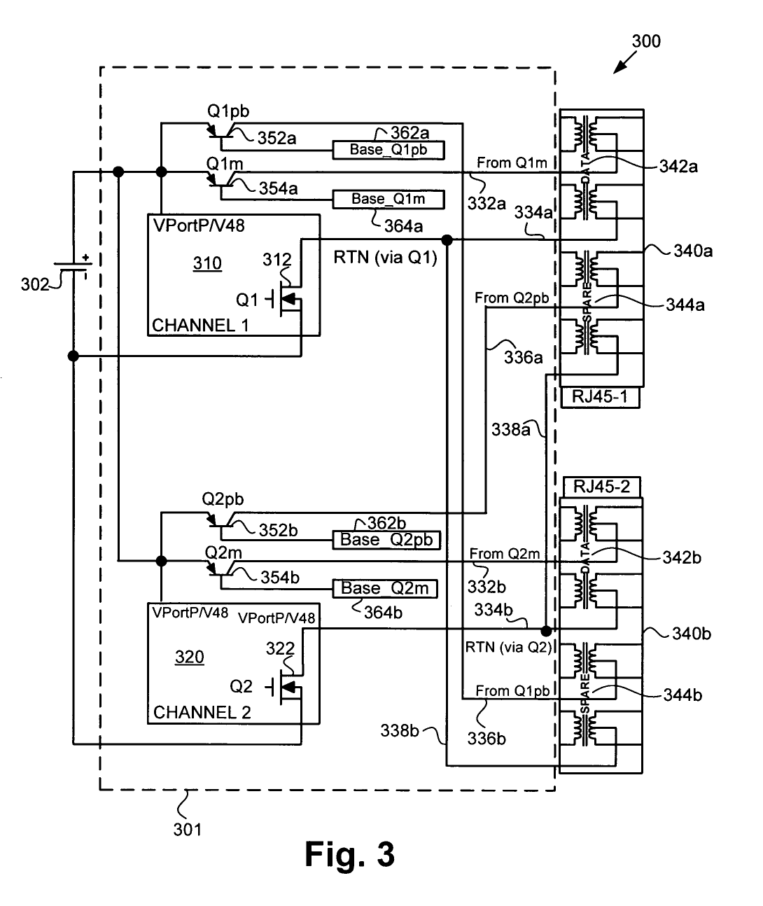

Referring to FIG. 3, FIG. 3 shows power sourcing equipment 300 for adaptively providing PoE, according to one embodiment of the present invention, capable of overcoming the drawbacks and deficiency attributable to conventional designs. As shown in FIG. 3, power sourcing equipment 300 may comprise circuit 301 including first power channel 310 and second power channel 320, voltage source 302, first network interface 340a, and second network interface 340b. Either of network interfaces 340a and 340b may be a pair of RJ45 registered jacks. Moreover, a network cable such as a CATS Ethernet cable may couple first network interface 340a to a powered device (not shown in FIG. 3) and another network cable such as another CATS Ethernet cable may couple second network interface 340b to another powered device (also not shown in FIG. 3).

First power channel 310 may comprise power switch 312 and second power channel 320 may comprise power switch 322, both shown as power transistors in the embodiment of FIG. 3, for example. Moreover, first network interface 340a may comprise two pairs of transformers, such as data pair 342a and spare pair 344a. Similarly, second network interface 340b may comprise two pairs of transformers, such as data pair 342b and spare pair 344b.

Data and spare lines 332a, 334a, 336a, 338a, 332b, 334b, 336b, and 338b may couple power channels 310 and 320 to network interfaces 340a and 340b. For instance, according to the embodiment shown in FIG. 3, data input line 332a and data return line 334a couple first power channel 310 to first network interface 340a, while spare input line 336b and spare return line 338b couple first power channel 310 to second network interface 340b. In addition, according to the present embodiment, data input line 332b and data return line 334b couple second power channel 320 to second network interface 340b, while spare input line 336a and spare return line 338a couple second power channel 320 to first network interface 340a.

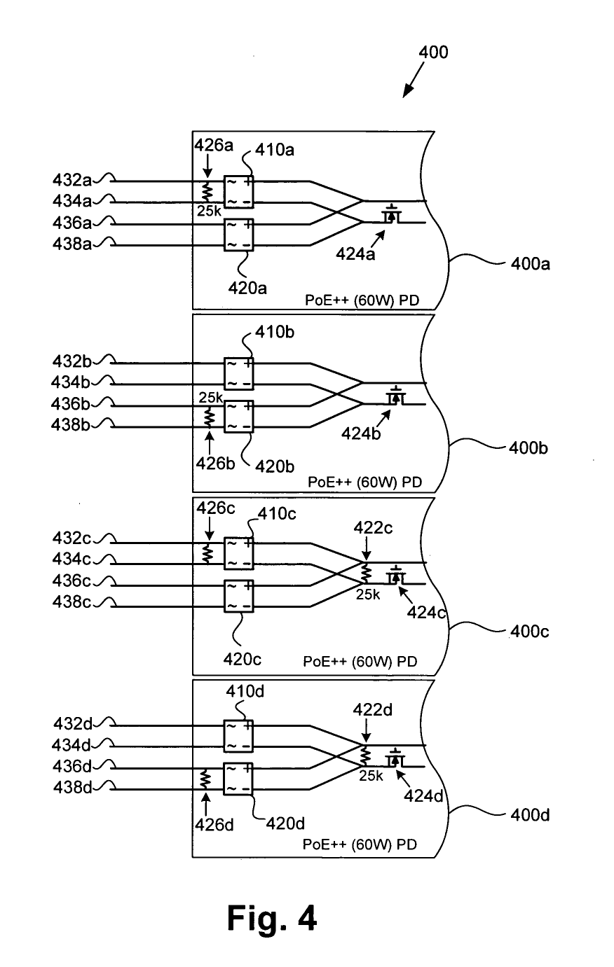

Circuit 301 of power sourcing equipment 300 may include exemplary shunt devices 352a and 352b, and main switches 354a and 354b for connecting power channels 310 and 320 to network interfaces 340a and 340b. As shown, in FIG. 3, first piggyback shunt device 352a may connect first power channel 310 to spare input line 336b, and first main switch 354a may connect first power channel 310 to data input line 332a. Similarly, second piggyback shunt device 352b may connect second power channel 320 to spare input line 336a, and second main switch 354b may connect second power channel 320 to data input 332b. As shown in FIG. 1, in one embodiment, any of shunt devices 352a and 352b, and main switches 354a and 354b may be a bipolar junction transistor (BJT). A processor (not shown in FIG. 3) may operate the control terminals, such as BJT base terminals 362a, 362b, 364a, and 364b of respective shunt devices 352a and 352b, and main switches 354a and 354b. The operation of power sourcing equipment 300 including circuit 301 will be more fully developed below, after discussion of FIG. 4.

Referring to FIG. 4, FIG. 4 shows powered devices 400 suitable for use with power sourcing equipment for adaptively providing PoE, according to four alternative embodiments including first powered device 400a, second powered device 400b, third powered device 400c, and fourth powered device 400d.

First powered device 400a may comprise data bridge rectifier 410a, spare bridge rectifier 420a, transmission gate 424a, and input resistor 426a. In this embodiment, input resistor 426a may have a resistance value of 25 kΩ for example, and be positioned across the input terminals of data bridge rectifier 410a. First powered device 400a may provide data input line 432a and data return line 434a to the terminals of data bridge rectifier 410a. First powered device 400a may also provide spare input line 436a and spare return line 438a to the terminals of spare bridge rectifier 420a.

The location of the input resistor in powered devices 400b, 400c, and 400d may be different than the location of the input resistor in first powered device 400a. Powered devices 400c and 400d may also include respective second internal resistors 422c and 422d. For example, second powered device 400b may comprise 25 kΩ input resistor 426b across the input terminals of spare bridge rectifier 420b. Moreover, third powered device 400c may comprise input resistor 426c having any resistance value across the input terminals of data bridge rectifier 410c and may further comprise second internal resistor 422c, such as a 25 kΩ resistor, for example, across the output terminals of data bridge rectifier 410c and spare bridge rectifier 420c. Finally, fourth powered device 400d may comprise input resistor 426d having any resistance value across the input terminals of spare bridge rectifier 420d and may further comprise second internal resistor 422d, such as a 25 kΩ resistor, for example, across the output terminals of data bridge rectifier 410d and spare bridge rectifier 420d.

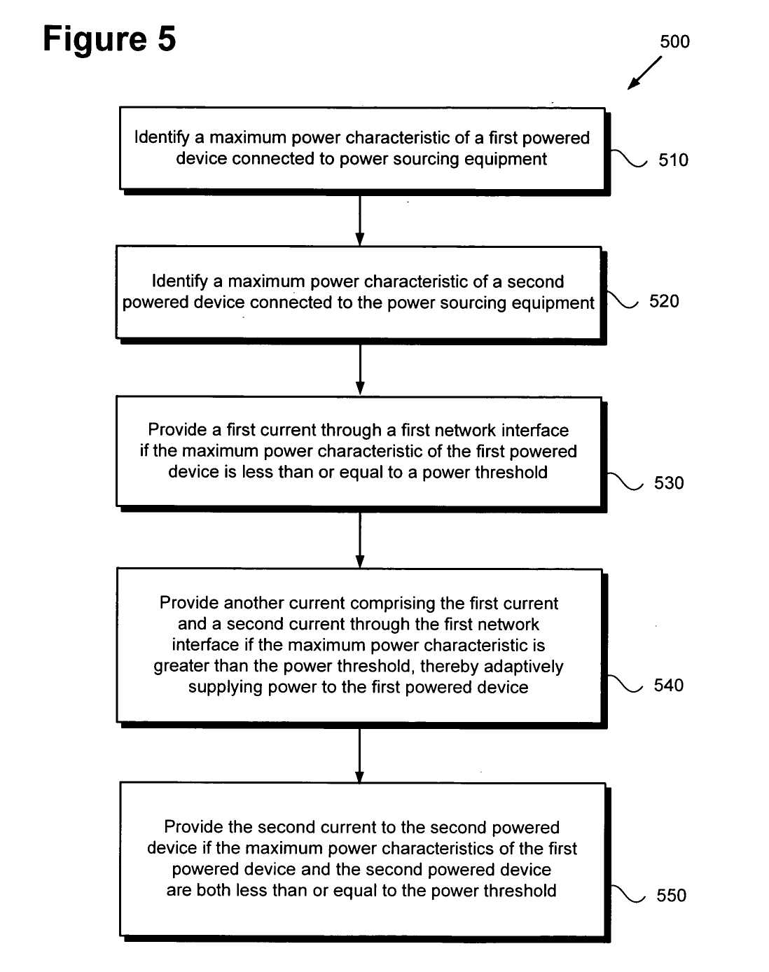

The operation of power sourcing equipment 300 including circuit 301, in FIG. 3, and powered devices 400a, 400b, 400c, and 400d, in FIG. 4 will be further described in combination with flowchart 500, shown in FIG. 5. Flowchart 500 describes the steps, according to one embodiment of the present invention, of a method for adaptively supplying PoE by power sourcing equipment. Certain details and features have been left out of flowchart 500 that are apparent to a person of ordinary skill in the art. For example, a step may comprise one or more substeps, as known in the art. While steps 510 through 550 indicated in flowchart 500 are sufficient to describe one embodiment of the present invention, other embodiments may utilize steps different from those shown in flowchart 500, or may include more, or fewer steps. Although the discussion of steps 510 through 550 will discuss the operation of an embodiment of the present invention using exemplary first powered device 4001 in FIG. 4, it is noted that in other embodiments the present invention may employ powered devices 400b, 400c, and 400d in FIG. 4 or other powered devices consistent with the present invention.

Referring to step 510 in FIG. 5, step 510 of flowchart 500 comprises identifying a maximum power characteristic of a first powered device connected to a power sourcing equipment. Referring to FIG. 3, step 510 may be performed by circuit 301 of power sourcing equipment 300. For example, step 510 may comprise determining whether a first input resistance of a powered device connected to first network interface 340a is substantially equal to a second input resistance of the powered device.

Determining a first input resistance may comprise closing first main switch 354a of circuit 301 and opening second main switch 354b and piggyback shunt devices 352a and 352b of circuit 301, each of shunt devices 352a and 352b, and main switches 354a and 354b depicted as transistor (e.g., BJT) switches in the embodiment shown by FIG. 3. In that embodiment, circuit 301 may be used by sourcing equipment 300 to determine a first input resistance based on the current flowing through power switch 312. Similarly, determining a second input resistance may comprise closing second piggyback shunt device 352b, and opening first piggyback shunt device 352a and main switches 354a and 354b. In this embodiment, circuit 301 may be used to determine a second input resistance based on the current flowing through power switch 322.

If the first input resistance of the powered device is substantially equal to the second input resistance of the powered device, power sourcing equipment 300 may identify the powered device as a conventional powered device like conventional powered device 200 in FIG. 2. In this case, power sourcing equipment 300 may identify the maximum power characteristic of the powered device as corresponding to a conventional powered device (e.g., a powered device requiring up to approximately 30 W).

On the other hand, if the first input resistance of the powered device is not substantially equal to the second input resistance of the powered device, power sourcing equipment 300 may identify the powered device as any of powered devices 400a, 400b, 400c, or 400d in FIG. 4, for example. In such a case, power sourcing equipment 300 may identify the maximum power characteristic of the powered device as corresponding to a higher power device (e.g., requiring up to approximately 60 W).

Although not expressly shown in flowchart 500, some embodiments of the present inventive method may also include steps to evaluate whether the powered device is faulty. Moreover, power sourcing equipment 300 may use circuit 301 to disable second network interface 340b if a high power device (e.g., a powered device requiring more than approximately 30 W) is detected as being connected to first network interface 340a.

However, if the powered device that is connected to first network interface 340a is a conventional powered device, circuit 301 may be used to execute step 520 in FIG. 5. Step 520 of flowchart 500 comprises identifying a maximum power characteristic of a second powered device connected to the power sourcing equipment. In one embodiment, step 520 may comprise determining whether a first input resistance of the second powered device is substantially equal to a second input resistance of the second powered device.

Determining a first input resistance of the second powered device may comprise closing second main switch 354b of circuit 301 and opening first main switch 354a and piggyback shunt devices 352a and 352b of circuit 301. In this embodiment, circuit 301 may be used to determine the first input resistance of the second powered device based on the current flowing through power transistor 322. Similarly, determining a second input resistance of the second powered device may comprise closing first piggyback shunt device 352a, and opening second piggyback shunt device 352b and main switches 354a and 354b. In this embodiment, circuit 301 may be used to determine a second input resistance of the second powered device based on the current flowing through power transistor 312.

If the first input resistance of the second powered device is substantially equal to the second input resistance of the second powered device, power sourcing equipment 300 may identify the second powered device as a conventional powered device like conventional powered device 200 in FIG. 2. In this case, power sourcing equipment 300 may identify the maximum power characteristic of the second powered device as corresponding to a conventional powered device (e.g., a powered device requiring up to approximately 30 W).

On the other hand, if the first input resistance of the second powered device is not substantially equal to the second input resistance of the second powered device, power sourcing equipment 300 may identify the second powered device as a powered device such as powered device 400a in FIG. 4. In such a case, power sourcing equipment 300 may identify the maximum power characteristic of the second powered device as corresponding to a higher power device (e.g., a powered device requiring more than approximately 30 W).

Returning to flowchart 500 in FIG. 5, step 530 of flowchart 500 comprises providing a first current through a first network interface if the maximum power characteristic of the first powered device is less than or equal to a power threshold. Returning to FIG. 3, power switch 312 may provide a first current from first power channel 310 over two of the four wire pairs of the Ethernet cable connecting the first powered device to first network interface 340a if the first powered device has a maximum power characteristic less than or equal to the 30 W power threshold of a conventional powered device. An embodiment of the present invention may therefore supply up to approximately 30 W of power to a conventional powered device.

To provide power over all four wire pairs of an Ethernet cable, an embodiment of the present invention may execute step 540 of flowchart 500 in FIG. 5. Step 540 of flowchart 500 comprises providing another current that comprises the first current and a second current through the network interface if the maximum power characteristic is greater than the power threshold, thereby adaptively supplying more power to the higher power first powered device.

Referring once again to FIG. 3, power switches 312 and 322 may provide another current over all four wire pairs of the Ethernet cable connecting the first powered device to first network interface 340a. The another current may comprise the first current supplied by first power channel 310 and a second current supplied by second power channel 320, the second current flowing over the remaining two wire pairs of the Ethernet cable. In this embodiment, power channels 310 and 320 may provide the another current only if the first powered device has a maximum power characteristic that is greater than the 30 W power threshold of a conventional powered device. Embodiments of the present invention may therefore adaptively supply power over four pairs of twisted wire of an Ethernet cable to a powered device requiring more than 30 W, for example.

To accommodate multiple conventional powered devices, an embodiment of the present invention may execute step 550 of flowchart 500 in FIG. 5. Step 550 comprises providing the second current to the second powered device if the maximum power characteristics of both the first and second powered devices are less than or equal to the power threshold. Returning to FIG. 3, second power channel 320 may provide the second current over two of the four twisted wire pairs of the Ethernet cable connecting the another powered device to second network interface 340b.

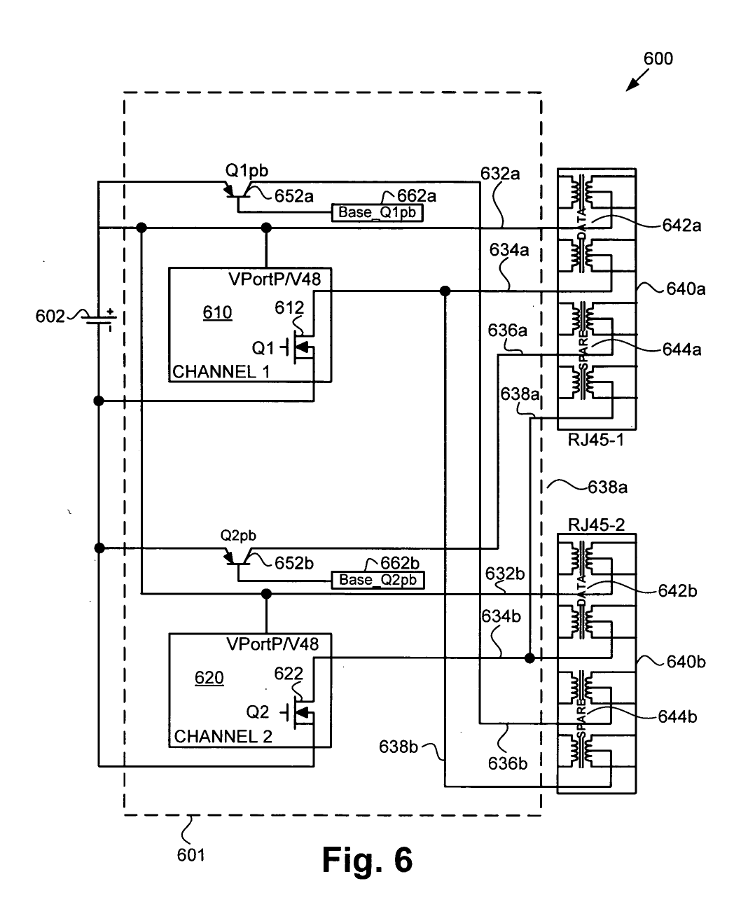

Referring to FIG. 6, FIG. 6 shows power sourcing equipment 600 according to an alternative embodiment of the present invention. Power sourcing equipment 600 including circuit 601 configured to adaptively provide power to one or more powered devices connected through first network interface 640a and second network interface 640b corresponds to power sourcing equipment 600 including circuit 301, in FIG. 3. Moreover, the additional features shown in FIG. 6 correspond respectively to the features described with respect to FIG. 3, according to their corresponding reference numbers. However, as further shown in FIG. 6, power sourcing equipment 600 need not have main switches corresponding to main switches 354a and 354b in power sourcing equipment 300 in FIG. 3. Power sourcing equipment 600 may adaptively provide power to one or more powered devices using methods as analogous to the exemplary method of flowchart 500 in FIG. 5.

Thus, embodiments of the present invention enable adaptive power sourcing for PoE applications. For instance, embodiments of the present invention adaptively assign power channels based on the operating requirements of a powered device. Additionally, embodiments of the present invention can disable unused ports to create a PoE system that is compatible with conventional lower power devices and that can meet safety, compatibility, and other requirements.

Moreover, power sourcing equipment according to embodiments of the present invention can flexibly allocate silicon based on the requirements of a given powered device, and can support both higher and lower power powered devices. Embodiments of the present invention are also compatible with existing hardware, such as CATS cables, and RJ45 registered jacks, for example.

From the above description of the invention, it is manifest that various techniques can be used for implementing the concepts of the present invention without departing from its scope. Moreover, while the invention has been described with specific reference to certain embodiments, a person of ordinary skill in the art would recognize that changes could be made in form and detail without departing from the spirit and the scope of the invention. It should also be understood that the invention is not limited to the particular embodiments described herein, but is capable of many rearrangements, modifications, and substitutions without departing from the scope of the invention.

What is claimed is:

1. A circuit enabling adaptive supplying of Power over Ethernet (PoE) by a power sourcing equipment including the circuit, the circuit comprising:
a first power channel and a second power channel coupled to first and second network interfaces of the power sourcing equipment;
at least one shunt device operated to identify a maximum power characteristic of a powered device connected to the first network interface;
the first power channel configured to provide a first current to the powered device through the first network interface if the maximum power characteristic is less than or equal to a power threshold;
the circuit configured to provide another current to the powered device through the first network interface if the maximum power characteristic is greater than the power threshold, the another current comprising the first current provided by the first power channel and a second current provided by the second power channel.

2. The circuit of claim 1, wherein the first network interface comprises an RJ45 registered jack.

3. The circuit of claim 1, wherein the second network interface comprises an RJ45 registered jack.

4. The circuit of claim 1, wherein the at least one shunt device comprises a bipolar junction transistor (BJT).

5. The circuit of claim 1, wherein the at least one shunt device comprises a plurality of shunt devices.

6. The circuit of claim 1, wherein the power threshold is approximately 30 W.

7. The circuit of claim 1, wherein the at least one shunt device is operated to identify whether a second input resistance of the powered device is substantially equal to a first input resistance of the powered device.

8. The circuit of claim 1, wherein the second power channel is configured to provide the second current to another powered device through the second network interface if the maximum power characteristic of the powered device is less than or equal to the power threshold.

9. The circuit of claim 8, wherein the circuit is configured to provide up to approximately 60 W if the maximum characteristic of the powered device is greater than the power threshold.

10. The circuit of claim 1, wherein the circuit is operated to disable the second network interface if the maximum power characteristic of the powered device is greater than the power threshold.

11. A method for adaptively supplying a Power over Ethernet (PoE) by a power sourcing equipment, the method comprising:
identifying a maximum power characteristic of a powered device connected to the power sourcing equipment;
providing a first current through a first network interface if the maximum power characteristic is less than or equal to a power threshold;
providing another current comprising the first current and a second current through the first network interface if the maximum power characteristic is greater than the power threshold, thereby adaptively supplying power to the powered device.

12. The method of claim 11, wherein identifying the maximum power characteristic of the powered device comprises determining whether a first input resistance of the powered device is substantially equal to a second input resistance of the powered device.

13. The method of claim 11, wherein the first network interface is one of a pair of network interfaces and the method further comprises disabling a second network interface of the pair of network interfaces if the maximum power characteristic of the powered device is greater than the power threshold.

14. The method of claim 11, further comprising:
identifying a maximum power characteristic of another powered device connected to the power sourcing equipment;
providing the second current to the another powered device if the maximum power characteristic of the powered device and the another powered device is less than or equal to the power threshold, thereby adaptively supplying power to the another powered device.

15. The method of claim 14, wherein identifying the maximum power characteristic of the another powered device comprises determining whether a first input resistance of the another powered device is substantially equal to a second input resistance of the another powered device.

16. The method of claim 14, wherein the power threshold is approximately 30 W.

17. The method of claim 11, wherein the first maximum power value corresponds to a power transmitted over two wire pairs within an Ethernet cable.

18. The method of claim 11, wherein the second maximum power value corresponds to a power transmitted over four wire pairs within an Ethernet cable.

19. The method of claim 11, wherein the first network interface comprises an RJ45 registered jack.

20. The method of claim 11, wherein the second network interface comprises an RJ45 registered jack.
